(19) United States
(12) Patent Application Publication
(10) Pub. No.: US 2006/0026813 A1
(43) Pub. Date: Feb. 9, 2006

(54) Piercing anchor plate assembly

(76) Inventor: Bill Whitaker, Addison, MI (US)

Correspondence Address: John G. Chupa, Esq.;Law Offices of John Chupa and Associates, P.C., Suite 50, 28535 Orchard Lake Road, Farmington Hills, MI, 48334, US

(21) Appl. No.: 11/246,537

(22) Filed: Oct. 7, 2005

Related U.S. Application Data
(63) Continuation of application No. 10/435,507, filed on May 9, 2003, now abandoned.

(51) Int. Cl. B23P 11/00

(52) U.S. Cl. 29/513; 411/466

(57) ABSTRACT

A piercing plate assembly (10) having a pair of longitudinal channels (14, 16) separated by an annular protuberance (24) which pierces a panel (106) and retains the panel slug (108) within the annular protuberance (24) while concomitantly deforming a portion of the annular protuberance (24) around and within a portion of the panel (109) thereby coupling the assembly (10) to the panel (106) and creating a sealed and supported aperture within said panel (106).

This is a continuation patent application for a prior U.S. patent application Ser. No 10/435,507 which was filed May 5, 2003. The present invention generally relates to a self piercing anchor plate assembly and, more particularly, to a self piercing anchor plate assembly having an annular panel piercing protuberance which pierces and partially protrudes through a panel and retains the panel slug within the protuberance, thereby sealing the panel while concomitantly providing a substantially rigid panel portion to which a plurality of assemblies may be attached in an efficient manner.

### FIELD OF THE INVENTION

### BACKGROUND OF THE INVENTION

Oftentimes, an attachment, such as and without limitation, shelves, compartments, light fixtures (e.g., automobile head lamps, tail lamps, and the like) are attached through a relatively thin and substantially weak surface of an object (e.g., sheet metal of an automobile, the interior or exterior surface of a conventional home or industrial appliance, and the like). For example and without limitation, appliances, such as conventional refrigerator/freezers, dishwashers, and the like, typically exterior coating, a layer of insulation, and a formed interior shell made from a conventional material (e.g., plastic). Particularly, the layer of insulation is typically poured, injected, or otherwise conventionally disposed between the metal housing and the formed interior shell. The conventional insulation (e.g., foam) is typically disposed between the housing and the formed interior shell while in a liquid state and may expand over a certain period of time. Importantly, the formed interior shell typically contains apertures through which components of the appliance (e.g., shelves, drawers, wine racks, and the like) may be attached, thereby undesirably providing several “escape” routes for the disposed insulation to drain or “run” out of the intended “target area” or location.

One known methodology for preventing the drainage of insulation through the formed interior shell requires the attachment of the appliance components through the created apertures of the interior shell prior to disposing the insulation between the housing and the interior shell. Although this known methodology does reduce the amount of insulation drainage, it does not completely obviate leakage of the insulation from the apertures of the interior shell around the attached components (i.e., leakage from the apertures and around the fastening devices which attach the appliance components). Furthermore, although this methodology may reduce the amount of insulation leakage, it does suffer from some drawbacks.

For example and without limitation, the expansion of the insulation through the apertures oftentimes uncouples the appliance components (e.g., the pressure of foam expansion may “blow out” or force the appliance component couplings through the apertures, thereby undesirably creating larger and, oftentimes unusable apertures, ruining the interior shell, damaging the appliance components, wasting insulation and,, ultimately, elevating the cost to produce the appliance.

In further example and without limitation, if the interior shell is not ruined and the appliance components do not become uncoupled from the insulation expansion or application process, the appliance components may eventually (i.e., over a period of time and under standard usage) wear the apertures through which they are coupled, thereby resulting in the appliance components becoming loose, noisy, unusable. (e.g., not able to withstand a load being applied upon it), and/or completely becoming dislodged from the interior shell. That is, the formed interior shell is conventionally formed from a relatively durable material, such as and without limitation, plastic, composite/fiber, and/or the like and, these types of materials are substantially “softer” or less-dense than the conventional metal attachment devices (e.g., screws, bolts, rivets, and/or the like) which are disposed through the apertures. The conventional metal fastening devices are less prone to wear than the apertures through which they are operatively disposed, therefore, the apertures may wear under normal operation over a period of time (e.g., normal operation creates vibration from operating the appliance, weight differences or varying loads placed upon or within the appliance components, varying temperatures, impact damages, such as the opening and closing of an appliance door, and/or the like).

There is therefore a need for an assembly which overcomes some or all of the previously delineated drawbacks of prior appliance insulation containment assemblies or methodologies. There is also a need for an assembly which obviates leakage of insulation through appliance attachment apertures in a manner which is both convenient and cost effective. There is still a further need for an assembly which provides structural support to appliance attachment apertures in a cost effective and convenient manner.

The present invention addresses these and other needs in a new and novel manner, as will be discussed in the following description of preferred embodiments, within the appended claims, and with reference to the following drawings.

### SUMMARY OF THE INVENTION

A first non-limiting advantage of the present invention is that it provides an assembly which allows for the attachment of appliance components in a manner which overcomes the previously delineated drawbacks of prior appliance insulating methodologies.

A second non-limiting advantage of the invention is that it provides a an assembly which allows for the attachment of appliance components in a manner which overcomes the previously delineated drawbacks of prior appliance insulating methodologies and more particularly a self piercing assembly which captures a formed interior shell plug of an appliance thereby providing an attachment point while concomitantly and removably sealing the attachment aperture.

A third non-limiting advantage of the present invention is that it provides a method for creating a sealed and supported aperture within a panel.

A fourth non-limiting advantage of the present invention is that it provides a self-piercing plate assembly comprising a generally rectangular and thin profile plate portion; and an annular protuberance which captures and removably contains a plug.

A fifth non-limiting advantage of the present invention is that it provides a method for creating a sealed and supported aperture in a panel. Particularly, the method comprises the steps of forming a plurality of assemblies comprising a generally rectangular and thin profile plate portion and an annular protuberance; providing a panel; forcing the annular protuberance of a respective one of the plurality of assemblies through the panel, thereby creating an aperture and a panel plug; and capturing the panel plug and containing the panel plug within the annular protuberance while the annular protuberance is being forced through the panel, thereby creating a sealed and supported aperture in the panel.

These and other features, aspects, and advantages of the present invention will become apparent from a reading of the following detailed description of the preferred embodiment of the invention and by reference to the following drawings.

### BRIEF DESCRIPTION OF THE DRAWINGS

FIG. 1 is a top view of a piercing anchor plate assembly which is made in accordance with the teachings of the preferred embodiment of the invention in an assembled relationship with a portion of a conventional appliance.

FIG. 2 is a side view of the assembly which is shown in FIG. 1.

FIG. 3 is a cut away view of the assembly which is shown in FIGS. 1 and 2, and which is taken along view line 3-3.

FIG. 4 is a side view of the assembly shown in FIG. 1-3 in an assembled relationship with a portion of a conventional appliance.

FIG. 5 is a bottom view of the piercing anchor plate assembly which is FIGS. 1-4 in an assembled relationship with a portion of a conventional appliance.

FIG. 6 is a partial perspective view of a conventional appliance in an assembled relationship with the piercing anchor plate assembly which is shown in FIGS. 1-5 and conventional appliance attachments.

FIG. 7 is a top view of a production roll of piercing anchor plate assemblies which is made in accordance with the teachings of the preferred embodiment of the invention.

FIG. 8 is a cut away view of a tool which is made in accordance with the teachings of an alternate embodiment of the invention in a disassembled relationship with a portion of a conventional appliance and the self piercing anchor plate assembly which is shown in FIGS. 1-6.

FIG. 9 is a cut away view of the tool which is shown in FIG. 8 in an assembled relationship with the portion of conventional appliance and the piercing anchor plate assembly which is shown in FIG. 8.

FIG. 10 is a top view of a piercing anchor plate assembly which is made in accordance with the teachings of an alternate embodiment of the invention.

FIG. 11 is a side view of the assembly which is shown in FIG. 1.

FIG. 12 is an end view of the assembly which is shown in FIGS. 11 and 12.

FIG. 13 is a top view of a piercing anchor plate assembly which is made in accordance with the teachings of yet another alternate embodiment of the invention.

FIG. 14 is a side view of the assembly which is shown in FIG. 13.

FIG. 15 is a top view of a piercing anchor plate assembly which is made in accordance with the teachings of yet another alternate embodiment of the invention.

FIG. 16 is a side view of the assembly which is shown in FIG. 15.

FIG. 17 is a partial perspective view of a bottom portion of a tool which is made in accordance with the teachings of an alternate embodiment of the invention.

FIG. 18 is a cut away view of the tool which is shown in FIG. 17.

FIG. 19 is a cut away view of the tool which is shown in FIG. 1 in cooperation with the piercing anchor plate assembly which is shown in FIG. 1.

### DETAILED DESCRIPTION OF THE PREFERRED EMBODIMENT OF THE INVENTION

The present invention may be understood more readily by reference to the following detailed description of preferred embodiments of the invention.

Before the present methods and apparatuses are disclosed and described, it is to be understood that the terminology used herein is for the purpose of describing particular embodiments only and is not intended to be limiting. It must be noted that, as used in the specification and the appended claims, the singular forms “a”, “an”, and “the” include plural referents unless the context clearly dictates otherwise.

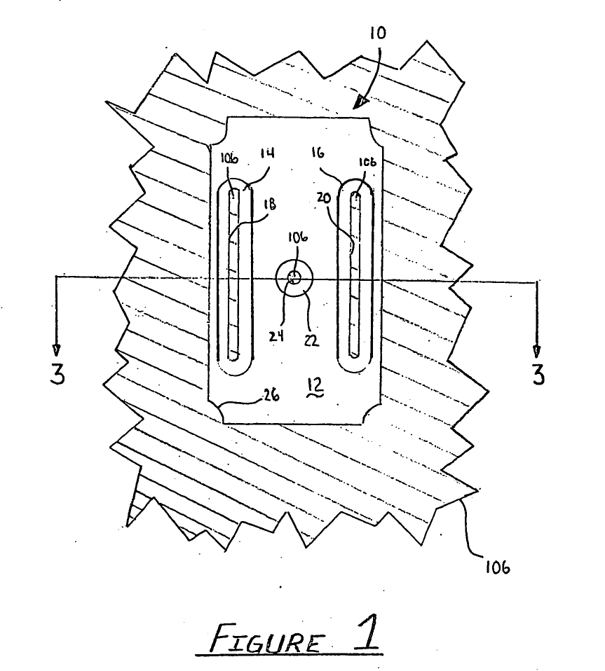

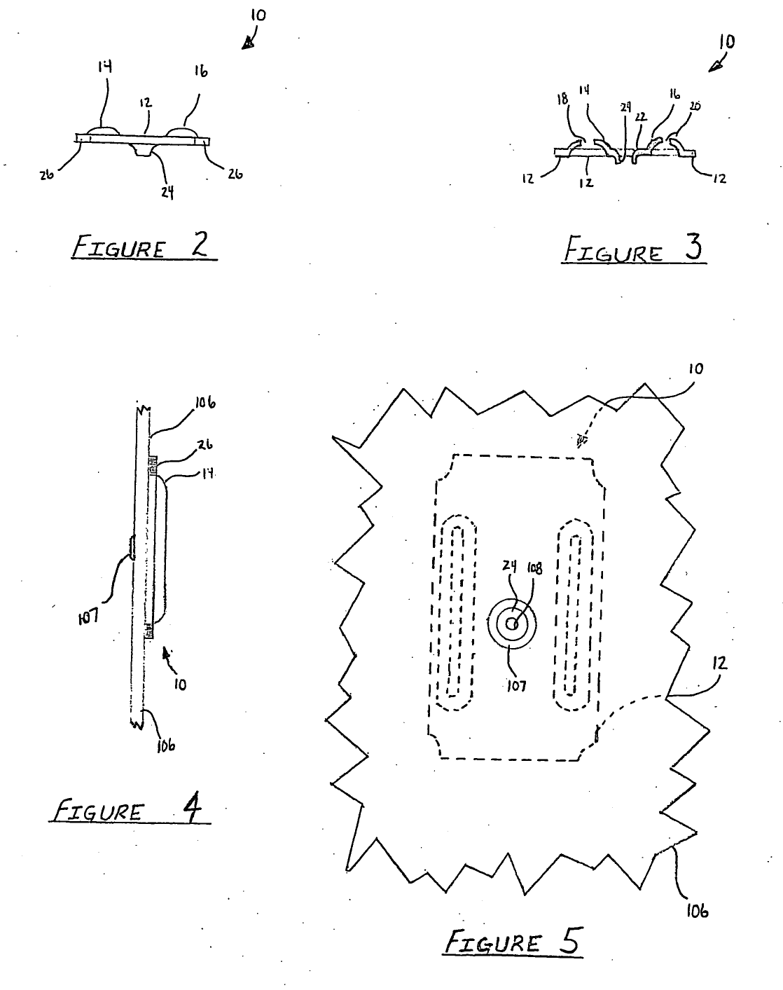

Referring now to FIGS. 1-5, there is shown a self-piercing anchor plate assembly or assembly 10 which is made in accordance with the teachings of the preferred embodiment of the invention. As shown, the assembly 10 includes a substantially thin profile and generally rectangular plate portion 12 having two substantially identical longitudinal channels or embossments 14, 16 and a non-tapered and generally circular panel-piercing annular protuberance 24 (i.e., the protuberance is substantially perpendicular to the rectangular plate portion 12 and has a uniform thickness).

As best shown in FIGS. 1, 4, and 5, the assembly 10 is operatively coupled to a formed interior shell 106 of an appliance, such as appliance 100 (as best shown in FIG. 6). At the outset, it should be understood that the shell 106 of an appliance is used in this description for illustrative purposes only and, the present invention may be used in an assembled relationship with substantially any desired material. For example and without limitation, the applications of the present invention are equally applicable to any surface which requires a strengthened aperture or a strengthened and sealed aperture (e.g., the exterior body panels of an automobile, substantially any desired sheet metal structure or surface, substantially any desired plastic or composite structure or surface, and/or the like). Particularly, the annular protuberance 24 of the plate 12 is forcibly engaged with the shell 106 such that the annular protuberance 24 pushes through or “pierces” the shell 106. More particularly, as the annular protuberance 24 is piercing the shell 106, the protuberance 24 creates a circular portion or “plug” of the shell 106 which resides within the non-tapered annular protuberance 24 and is retained within the inner race of the annular protuberance 24. That is, the protuberance 24 forces a plug 108 of shell 106 from the shell 106 and captures the plug 108 within the annular protuberance 24, thereby creating an aperture through the shell 106 while concomitantly sealing the aperture with the plug 108. In this manner, the annular protuberance 24 may cooperate with a conventional thread-forming screw to fasten the assembly 10 to a surface, such as shell 106 (i.e., the thread-forming screw will form threading within the inner race of the protuberance 24 while concomitantly forcing out the plug 108 which is contained within the annular protuberance 24).

As shown, the two substantially identical longitudinal channels 14, 16 each include a respective longitudinal slot 18, 20 which, when coupled to a formed shell, create a longitudinal cavity 107 which may be filled with substantially any desired conventional or commercially available material, such as and without limitation, a conventional epoxy, foam insulation, and/or the like. In this manner, the longitudinal channels 14, 16 serve to strengthen or rigidize the plate 12, as well as obviate rotational movement of the assembly 10 while coupled to the shell 106. That is, the conventional material which is used to fill the longitudinal cavities 107 may be disposed through the respective slots 18, 20 until the material begins to “over-flow” out of the slots 18, 20. In this manner, the cavities 107 will be completely filled with a material that bonds to the shell 106, the interior of the cavities 107, and protrudes from the slots 18, 20, thereby substantially rigidizing the assembly 10 and obviating rotational movement of the assembly 10.

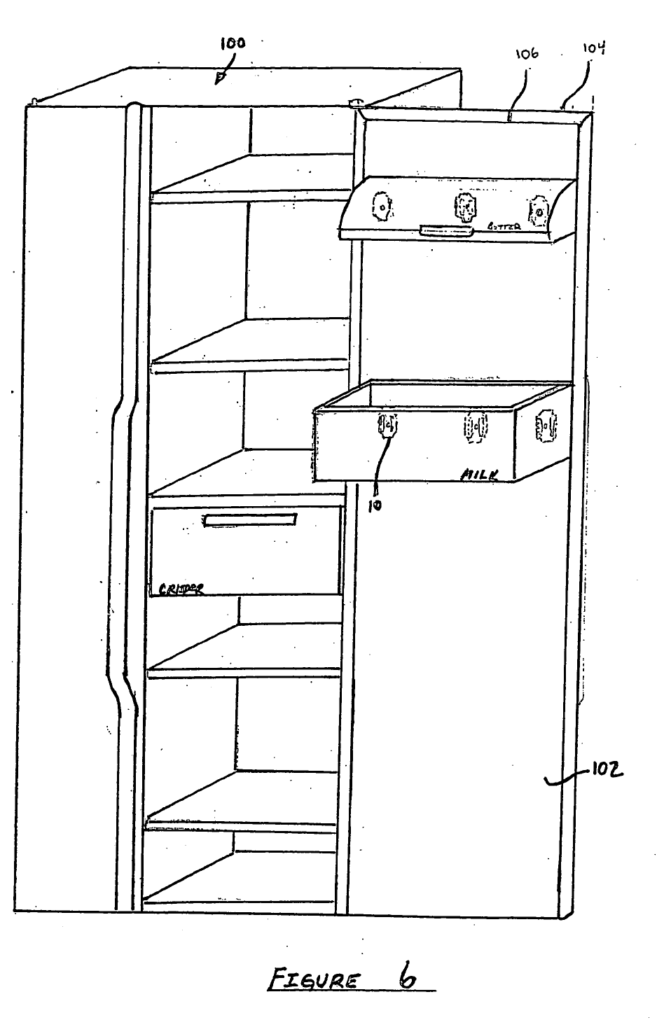

Referring now to FIG. 5, there is shown a portion of a formed shell 106 having an assembly 10 coupled there through (i.e., the annular protuberance 24 is forced through the shell 106 such that the surface of the shell 106 deforms around the protuberance 24 in a generally circular raised portion 109). Particularly, the annular protuberance 24 protrudes through the shell 106 and retains the plug 108 within the inner race of the annular protuberance while the raised portion 109 substantially houses the annular protuberance 24. That is, the raised portion 109 protrudes from the shell 106 further than the annular protuberance 24 protrudes into the raised portion 109. In this manner, the annular protuberance 24 does not protrude through the shell 106, thereby creating a filled aperture which does not leave a sharp edge on the surface to which appliance components, such as components 118, 114 are abutted and attached (i.e., the raised portion 109 creates a substantially flush attachment surface which does not require any additional tooling or “filing” of sharp metal in order to flushly abut and attach an appliance component). It should be appreciated that, in other non-limiting embodiments, the annular protuberance 24 may protrude out of the raised portion 109 and be deformed around the portion 109 to ensure that the assembly 10 is rigidly coupled to the shell 106.

Referring now to FIG. 7, there is shown a plurality of assemblies 10 which are each removably attached to a respective assembly 10 at a respective side 11. Particularly, the plurality of assemblies 10 are shown as a production roll which has not been disassembled for individual use. That is, in the preferred embodiment of the invention, the assemblies 10 are produced from a uniform piece or “roll” of tool steel and fed through a conventional tool forming machine (e.g., progression dies, transfer dies, staking dies, and/or the like) having a striking portion (e.g., a top moving portion or a “ram”) and an impact receiving portion (e.g., a bottom stationary portion or a “bolster”). In this manner, the assemblies 10 may be produced quickly and conveniently and sold or shipped in rolls or “reels” (i.e., supplied to a buyer in “strips”) for use with automatic installation tooling.

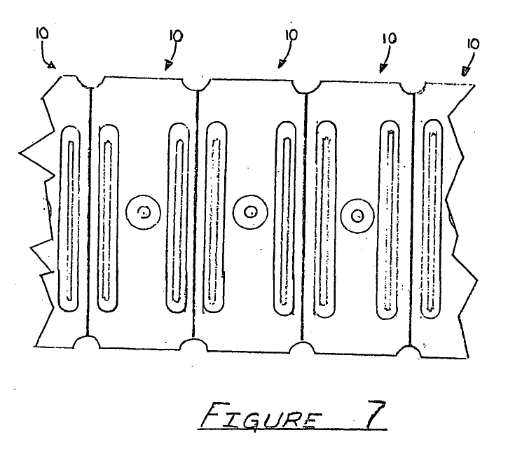

Referring now to FIGS. 8-9, there is shown one non-limiting embodiment of the tool used to couple or pierce the formed shell 106 with the assembly 10. As shown, the assembly 10 is removably coupled to a top portion 201 of an assembly tool 200 in a conventional manner. Particularly, the assembly 10 is removably coupled to the top portion 201, such that the annular protuberance 24 is facing downward (i.e., away form the top portion 201) and the channels 14, 16 are facing the top portion 201 (i.e., the surface between the channels 14, 16 of assembly 10 abuts the top portion 201). Tool 200 further includes a bottom portion 202 which includes a generally circular and hollow cylinder 204 which receives a selectively movable piston 206.

Piston 206 includes a tapered impact portion 210 which has a first diameter 211 and a second diameter 213. Particularly, the first diameter 211 is smaller than the second diameter 213 and the inner race of the annular protuberance 24. In this manner, the first diameter 211 of the piston 206 may traverse into the annular protuberance 24 while the second diameter 213 of the piston 206 may not traverse into the annular protuberance 24.

The bottom portion 202 of the tool 200 further includes a generally circular recessed portion 208 which is formed into the surface 203, and which has a diameter that is substantially greater than the second diameter 213 of the piston 206. The inner race of recessed portion 208 is slightly larger than the outer race of the annular protuberance 24 and, in this manner, the annular protuberance 24 may wholly reside within the recessed portion 208.

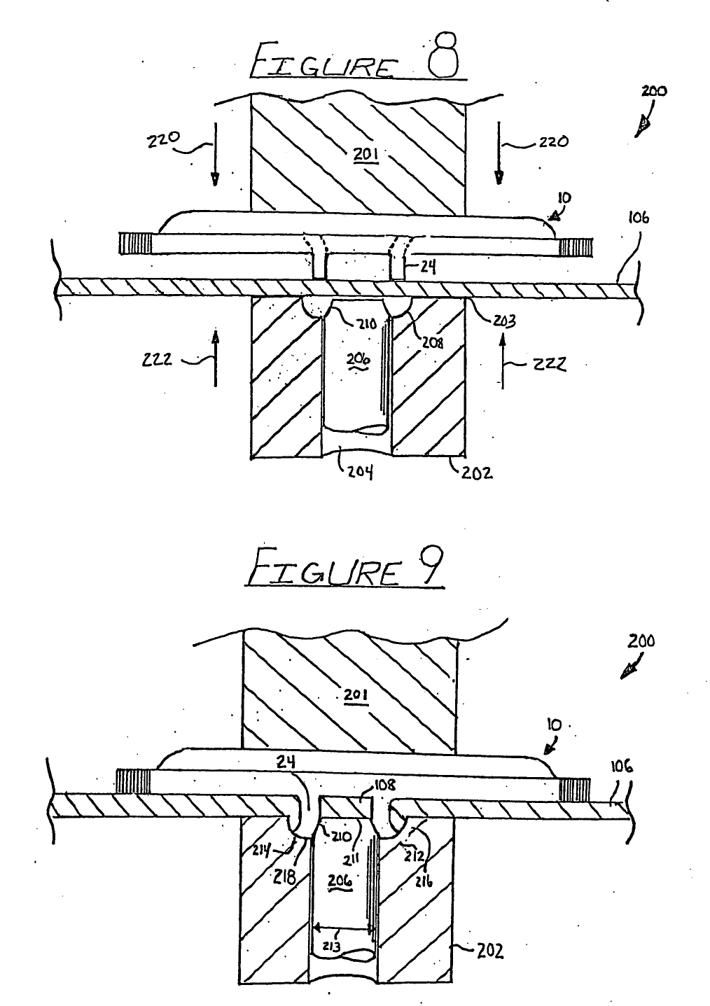

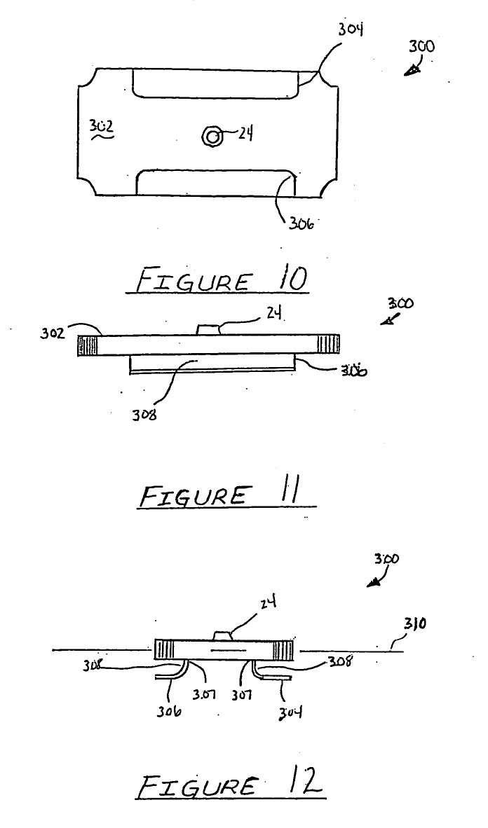

Referring now to FIGS. 10-12, there are shown several views of a plate assembly 300 which is made in accordance with the teachings of an alternate embodiment of the invention. As shown, the plate assembly 300 is substantially similar to the plate assembly 10 with the exception that the two substantially identical and longitudinal channels or embossments 14, 16 are replaced by a pair of opposing flanges 304, 306 respectively. That is, as can best be viewed in FIG. 12, each respective flange 304, 306 is either integrally formed with or attached to the plate portion 302 in a conventional manner (e.g., stamped, welded, and/or the like) and includes two generally “L” shaped portions 307 which extend downward from the plate 304 and towards a respective and opposing edge of the plate 302 (i.e., downward and towards an opposing edge of the plate 302, such that each flange is parallel to the plane 310 of the plate 304), thereby forming two substantially identical and opposing generally “U” shaped cavities 308. Each respective cavity 308 may be easily filled with a conventional bonding material, such as and without limitation glue or foam insulation, thereby obviating rotational movement (i.e., either clockwise or counter-clockwise movement) of the assembly 300 when coupled to a shell, such as and without limitation shell 106.

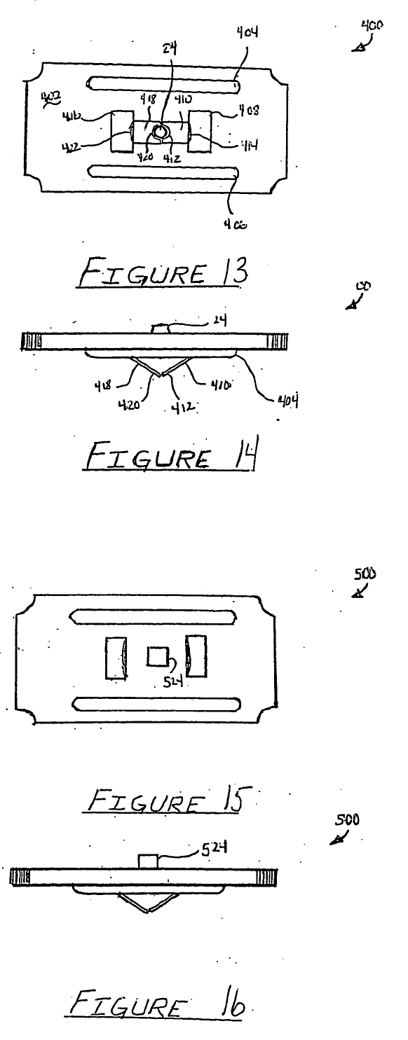

Referring now to FIGS. 13-14, there is shown a plate assembly 400 which is made in accordance with the teachings of yet another alternate embodiment of the invention. As shown, the plate assembly 400 includes a plate portion 402 which is substantially similar to the plate portions 12 and 302, two substantially identical longitudinal embosses 404 and 406, and an annular protuberance 24. Assembly 400 further includes two substantially identical and generally rectangular apertures 408, 416 which each include an integrally formed and opposing arm portion 410, 418 respectively. Particularly, each respective arm portion 410, 418 includes an arcuate recess 412, 420 respectively which, when the arm portions 410, 418 are forced together (i.e., when the arcuate recess 412 is substantially abutting the arcuate recess 420), form a generally circular aperture through which a conventional sheet metal screw (not shown) may be disposed and threadingly engaged. That is, the angle of the arm portions 412, 420 with respect to the plate portion 402 (i.e., an acute angle) create an edge upon the arcuate recesses which conventional threading of a screw may cooperate to threadingly engage. In this manner, the annular protuberance 24 need not be generally circular in order to receive a thread forming screw. Rather, the protuberance 24 may be substantially any desired geometrical shape, such as the generally square protuberance 524 which is shown in FIGS. 15 and 16.

That is, as best shown in FIGS. 15-16, there is shown a plate assembly 500 which is made in accordance with the teachings of yet another alternate embodiment of the present invention. As shown, the plate assembly 500 is substantially identical to the plate assembly 400 with the exception that the annular protuberance 24 is replaced by a generally square protuberance 524. In this manner and since the protuberance 524 is not required to cooperate with a thread-forming screw, the generally square protuberance 524 may be used as another form of anti-rotational movement of the assembly 500 when coupled to a surface, such as shell 106. It should be appreciated that the assemblies 10, 300, 400, 500 allow a user to selectively choose substantially any desired threaded fastener (for use with the assemblies 300, 400, 500) or choose a thread forming screw (for use with the assembly 10), thereby allowing a user to use one of a plurality of the threaded fastening devices which may be required to assemble the object (e.g., appliance, automobile, and/or the like) to which the assemblies 300, 400, 500 may be selectively attached.

It should be appreciated that in other non limiting embodiments, each of the aforementioned plate assemblies 10, 300, 400, 500 may comprise flanges, such as flanges 304, 306, embossments, such as embossments 404, 406, or longitudinal channels, such as channels 14, 16 and, nothing within the descriptions of preferred or alternate embodiments is meant to limit the plate assemblies 10, 300, 400, 500 to any particular flanges, embossments, or channels.

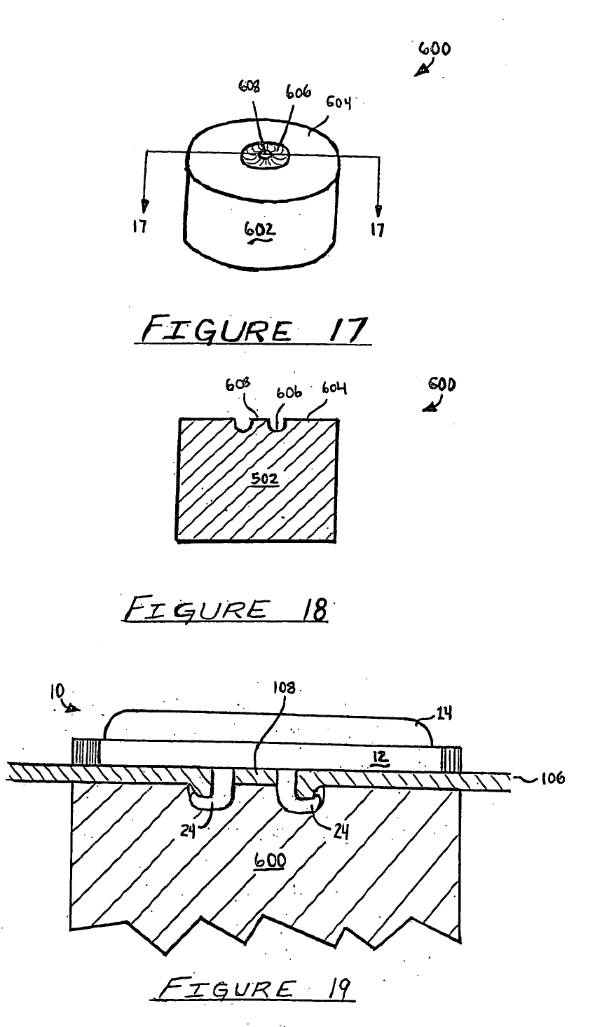

Referring now to FIGS. 17-19, there is shown a bottom portion 602 of a tool 600 which is made in accordance with the teachings of an alternate embodiment of the invention. As shown, bottom portion 602 is generally circular in shape and includes a generally circular or “ring-shaped” recess 606 which circumscribes a generally circular surface 608. Particularly, the generally circular surface or “plateau” 608 is substantially flush with the top surface 604 and, in this manner, the bottom portion 602 of tool 600 may comprise one solid piece of tool steel. That is, with reference to the tool 200, the bottom portion 502 does not include a selectively movable piston 206 or a cylinder 204, thereby obviating any moving parts or components. More importantly, the generally ring shaped recess 606 performs substantially the same function as the generally circular recess 208 of the tool 200. That is, as is best shown in FIG. 19, the generally ring shaped recess 606 in cooperation with the plateau portion 608 respectively serve to selectively deform the protuberance 24 (i.e., either square or annular) around the shell 106, as well as maintain the plug 108 within the inner race of the protuberance 24.

In operation, a formed shell, such as shell 106 is placed upon either of the surfaces 203, 604 of the bottom portion 202, 602 of tool 200, 600 (i.e., the formed shell 106 is placed in a position which aligns the piston 206 or the plateau 608 with the area upon the formed shell 106 that a user desires to pierce with the annular protuberance 24 or the square protuberance 524). It should be understood that the following description of operation is equally as applicable to the tool 600, however for descriptive purposes only, the following description will only include reference to the tool 200. Next, an assembly 10 is removably coupled to the top portion 201 of the tool 200, such that the annular protuberance 24 is facing the bottom portion 202 (i.e., in a position which aligns the annular protuberance 24 with the piston 206). Upon aligning the shell 106 to a desired position, the piston 206 is moved in the direction of the arrows 222 while the top portion 201 is moved in the direction of the arrows 220. In this manner, the annular protuberance is abutted to the shell 106 and forced through the shell 106. The piston 206 serves to ensure that the plug 108 remains within the annular protuberance 24 while the tapered impact portion 210 forces the annular protuberance 24 outward and around the displaced portions 216, 218 of the shell 106. That is, as the annular protuberance 24 pushes through the shell 106, the shell 24 deforms around the protuberance 24, thereby forming the raised portion 109 and, as the annular protuberance 24 pushes completely through the shell 109, the protuberance 24 enters the recessed portion 208 of the bottom portion 202 and becomes outwardly deformed by the tapered impact portion 210 of the piston 206, thereby attaching the assembly 10 to the shell 106 while capturing the plug 108 within the annular protuberance 24. It should be understood that the coupling or attachment of the assembly 10 to the shell 106 may be performed by a hand crimping tool (not shown), a press, automatic tooling, and/or the like and, nothing within this description is meant to limit the attachment of the assembly 10 to any particular electrical, mechanical, or manual procedure.

It should be appreciated that the assembly 10 provides a substantially rigid and durable aperture through which an appliance attachment may be coupled. It should be further appreciated that the assembly 10 further provides a sealed aperture which obviates any leakage of insulating material through the annular protuberance 24. It should also be appreciated that the assembly 10 also obviates any rotational movement of the assembly 10 while coupled to the shell 106. That is, the channels 14, 16 provide strength to the created aperture, as well as obviate rotational movement of the assembly 10 when the channels 14, 16 are filled with a conventional bonding agent (e.g., glue) or with conventional foam insulation.

It should be understood that this invention is not limited to the exact construction or embodiments listed and described, but that various changes may be made without departing from the spirit and scope of the invention. For example and without limitation, the assembly 10 may pierce through a thin metal material rather than a substantially thin plastic material.

What is claimed is:

1) A self-piercing plate assembly comprising:
a generally rectangular and thin profile plate portion; and
a non-tapered and uniform thickness protuberance which captures and removably contains a plug; and
at least one longitudinal support portion which partially traverses said plate portion.

2) The assembly of claim 1 further comprising a top side and a bottom side, wherein said at least one longitudinal support portion protrudes from said top side, and wherein said protuberance protrudes from said bottom side.

3) The assembly of claim 2 wherein said at least one longitudinal support portion comprises two substantially identical longitudinal support portions which are longitudinally formed on one side of said plate portion and separated by said protuberance.

4) The assembly of claim 3 wherein each of said assemblies are formed from a uniform roll of tool steel and removably coupled to a respective and substantially identical assembly.

5) The assembly of claim 4 further comprising a pair of generally rectangular apertures which are separated by said protuberance, said pair of apertures each including an arm portion which diagonally extends from one side of said aperture and over said protuberance.

6) The assembly of claim 5 wherein each of said arm portions are integrally formed with said plate, said arm portions each having and arcuate recess, said arcuate recesses abutting to form a generally circular aperture over said protuberance.

7) The assembly of claim 6 wherein said protuberance is annular.

8) The assembly of claim 6 wherein said protuberance is generally square.

9) The assembly of claim 4 wherein said longitudinal support portions each comprises a channel having a slot aperture which receives a material and contains said material within said channel.

10) The assembly of claim 4 wherein said longitudinal support portions comprises two opposing flanges which are separated by said protuberance, each of said opposing flanges cooperating with said plate portion to form a respective cavity, wherein said opposing flanges are generally l-shaped and perpendicularly project away from said plate portion and bend away from said protuberance until a portion of said opposing flanges are parallel to said plate.

11) The assembly of claim 4 further comprising a selectively movable tool having a top portion and a bottom portion, wherein said top side of said assembly is removably coupled to said top portion of said tool, and wherein said bottom portion of said tool receives a portion of a conventional appliance.

12) The assembly of claim 11 wherein said bottom portion of said tool comprises:
a generally circular recess having a first diameter;
a cylinder having a second diameter which is smaller than said first diameter, said cylinder being formed within and concentric to said recess;
a piston which is disposed within said recess and said cylinder, said piston having a third and a fourth diameter, wherein said third diameter is smaller than said second diameter, and wherein said fourth diameter is smaller than said third diameter.

13) The assembly of claim 12 wherein said protuberance has a fifth diameter, said fifth diameter of said protuberance is slightly larger than said fourth diameter of said piston, and wherein said third diameter of said piston is larger than said fifth diameter of said protuberance.

14) The assembly of claim 11 wherein said bottom portion comprises:
a generally circular recess having a first diameter; and
a generally circular plateau having a second diameter, wherein said generally circular recess circumscribes said generally circular plateau.

15) The assembly of claim 14 wherein said protuberance has a certain diameter, said certain diameter of said protuberance being larger than said second diameter of said plateau and smaller than said first diameter of said generally circular recess.

16) A method for creating a sealed and supported aperture in a panel, said method comprising the steps of:
forming a plurality of assemblies comprising a generally rectangular and thin profile plate portion and a protuberance;
providing a panel;
forcing said protuberance of a respective one of said plurality of assemblies through said panel, thereby creating an aperture and a panel plug; and
capturing said panel plug and containing said panel plug within said protuberance while said protuberance is being forced through said panel, thereby creating a sealed and supported aperture in said panel.

17) The method of claim 16 wherein said step of forming a plurality of assemblies further comprises the steps of:
providing a roll of tool steel; and
producing said plurality of assemblies which are each removably coupled to at least a respective one of said plurality of assemblies.

18) The method of claim 17 wherein each of said plate assemblies further comprise a respective top side and a respective bottom side, said method further comprising the steps of:
forming at least one longitudinal support portion upon each of said first sides of each of said plate portions; and
forming said protuberance through said first side, such that said protuberance projects from said second side of each of said plate assemblies.

19) The method of claim 18 wherein said step of forcing said protuberance of a respective one of said plurality of assemblies through said panel further comprises the steps of:
providing a selectively movable tool having a top portion and a bottom portion;
removably coupling said top side of a respective one of said plurality of assemblies to said top portion of said tool; and
causing said bottom portion of said tool to receive a portion of said panel.

20) The method of claim 19 wherein said step of providing a selectively movable tool having a top portion and a bottom portion further comprises the step of forming a generally ring shaped recess having a first diameter within said bottom portion of said tool, thereby providing a generally circular plateau portion having a second diameter, wherein said generally ring shaped recess circumscribes said generally circular plateau portion.

21) The method of claim 20 wherein said step of forcing said protuberance of a respective one of said plurality of assemblies through said panel further comprises the steps of:
moving said top portion of said tool towards said bottom portion of said tool;
forcing one of said assemblies into said panel with said top portion of said tool; and
forcing said protuberance through said panel while said second diameter of said plateau maintains said plug within said protuberance and while said first diameter of said recess deforms a portion of said protuberance around said panel.

22) The method of claim 20 wherein said step of forming a generally ring shaped recess having a first diameter within said bottom portion of said tool further comprises the steps of:
forming a cylinder having a second diameter which is smaller than said first diameter, said cylinder being formed within and concentric to said recess;
forming a piston having a third and a fourth diameter, wherein said third diameter is smaller than said second diameter, and wherein said fourth diameter is smaller than said third diameter;
disposing said piston within said cylinder, such that said fourth diameter of said piston is in close proximity to said recess.

23) The method of claim 22 wherein said step of forcing said protuberance of a respective one of said plurality of assemblies through said panel further comprises the steps of:
moving said top portion of said tool towards said bottom portion of said tool while concomitantly moving said piston towards said top portion of said tool;
forcing one of said assemblies into said panel with said top portion of said tool; and
forcing said protuberance through said panel while said fourth diameter of said piston maintains said slug within said protuberance and while said third diameter of said piston deforms a portion of said protuberance around said panel.

24) The method of claim 23 wherein said at least one support portion comprises two substantially identical longitudinal channels each having a respective longitudinal slot aperture, and wherein said panel and said two longitudinal channels form two cavities when said assembly is coupled to said panel, said method further comprising the steps of:
providing an amount of adhesive;
disposing said amount of adhesive through said respective slot apertures and within said cavities; and allowing said disposed amount of adhesive to bond to said panel and within said cavities, thereby obviating rotational movement of said assembly while coupled to said panel.

25) The method of claim 18 wherein said at least one support portion comprises two generally l-shaped and opposing flanges which are separated by said protuberance, each of said opposing flanges perpendicularly projecting from said plate and bending away from said protuberance until a portion of each of said flanges is parallel to said plate.

26) The method of claim 25 further comprising the steps of:
providing an amount of material; and
disposing said amount of material between said plate and each of said portions of said flange which are parallel to said plate.

27) The method of claim 26 wherein said protuberance is annular.

28) The method of claim 18 wherein said at least one support portion comprises two substantially identical embossments which are separated by said protuberance.

29) The method of claim 28 wherein said step of forming a plurality of assemblies comprising a generally rectangular and thin profile plate portion and a protuberance further comprises the step of forming a pair of generally rectangular apertures which are separated by said protuberance, said pair of apertures each including an arm portion which diagonally extends from one side of said aperture and over said protuberance.

30) The method of claim 29 wherein each of said arm portions are integrally formed with said plate portion, said method further comprising the steps of:
forming an arcuate recess upon an end of each of said arm portions;
causing said arm portions to abut over said protuberance, such that said arcuate recesses form a generally circular aperture over said protuberance.
